(19) United States
(12) Patent Application Publication
(10) Pub. No.: US 2005/0150902 A1
(43) Pub. Date: Jul. 14, 2005

(54) Cap device for mixing different kinds of materials separately contained therein and in bottle

(76) Inventor: Young Kook Cho, Huntington Park, CA (US)

Correspondence Address: Jerry H. Noh;Suite 2741, 3435 Wilshire Blvd, Los Angeles, CA, 90010, US

(21) Appl. No.: 11/017,310

(22) Filed: Dec. 18, 2004

(30) Foreign Application Priority Data
Dec. 30, 2003 (KR) 10-2003-0101043

(51) Int. Cl. B67D 5/14

(52) U.S. Cl. 222/58; 222/630; 222/196

(57) ABSTRACT

A cap device for bottles which contains an additive in an additive container thereof and discharges the additive from the additive container into a bottle according to a predetermined movement of a part of the cap device, thus introducing the additive into the bottle and thus mixing the additive with a bottled liquid to prepare a mixture and allowing a user to easily prepare the mixture just prior to consuming or using the mixture. The cap device has an actuating unit to actuate the additive container while movably supporting the additive container. The actuating unit includes a body provided on the cap body, with the additive container received in the body to be moved vertically relative to both the body and the cap body. At least one aim is coupled to the body, and a head is mounted on the body.

### BACKGROUND OF THE INVENTION

1. Field of the Invention

The present invention relates, in general, to cap devices for bottles containing therein a variety of liquids, such as beverages, liquid medicines or liquid chemicals, and, more particularly, to a cap device for bottles, which contains an additive therein and is secured to the mouth of a bottle, and discharges the additive into the bottle according to a rotation of a part of the cap device, thus introducing the additive into the bottle and thus mixing the additive with a bottled liquid to prepare a mixture and allowing a user to easily prepare the mixture just prior to consuming or using the mixture.

2. Description of the Related Art

In the related art, most of the conventional disposable bottles sold in markets each contain therein only a single liquid, such as a beverage, a liquid medicine or a liquid chemical, and are closed by caps at the mouths thereof When a user desires to add an additive to the liquid contained in such a capped bottle so as to prepare a mixture prior to consuming or using the mixture, the user must add the additive from a separate vessel to the bottled liquid after removing a cap from the bottle. Therefore, it is necessary for manufacturers of the additives and the bottled liquids to contain such additives and liquids in separate vessels and bottles prior to selling them, thus undesirably wasting resources due to the production of the separate vessels and capped bottles. In addition, the adding of the additive from the separate vessel to the bottled liquid to mix them after removing the cap from the bottle is inconvenient and costly to the user in that the user is must separately purchase and handle the additive vessel and the bottle.

Furthermore, it is extremely difficult for the user to add a precise amount of the additive from the separate vessel to the liquid contained in the bottle, so that the user roughly measures the additive to be added to the bottled liquid. Therefore, in the case of mixing of an additive with a bottled beverage to produce a mixed beverage, the rough measurement of the additive may result in changes in the taste and quality of the mixed beverage. In the case of mixing of an additive with a bottled liquid medicine or a bottled liquid chemical to produce a mixed medicine or a mixed chemical, the rough measurement of the additive may result in incomplete dissolution of effective ingredients of the additive in the medicine or the chemical and a failure of accomplishment of desired medical or chemical effects of the mixed medicine or the mixed chemical.

Of course, when mixtures are prepared by manufacturers in factories and are sold in a bottled state, in place of allowing users to mix additives with bottled liquids to prepare mixtures just prior to consuming or using the mixtures, it is possible to avoid the above-described problems that may arise in the mixing of the additives with the bottled liquids performed by the users. However, the mixtures which are prepared by the manufacturers and sold in the bottled state are problematic in that the effects of ingredients of the bottled mixtures may be gradually degraded as time goes by, in addition to changes in colors of the mixtures. Furthermore, the bottled mixtures may generate floating matters and deposits therein with passage of time.

In an effort to overcome the above-described problems, the present invention provides a cap device for bottles, which has an additive containing chamber to contain an additive therein and is secured to the mouth of a bottle that contains a liquid therein. The cap device discharges the additive into the bottle according to a rotation of a part of the cap device, thus introducing the additive into the bottle and thus mixing the additive with the liquid in the bottle to prepare a mixture and allowing a user to easily prepare the mixture just prior to consuming or using the mixture. With the use of the cap device, the user can easily prepare the new mixture prior to consuming or using the new mixture. Furthermore, the cap device eliminates the necessity of a separate production of the vessels for additives and the capped bottles, thus preventing the excessive consumption of resources and protecting environment by reducing the amount of wastes.

### SUMMARY OF THE INVENTION

Accordingly, the present invention has been made keeping in mind the above problems occurring in the related art, and it is an aspect of the present invention to provide a cap device for bottles, which contains an additive in an additive container thereof and is secured to the mouth of a bottle, and discharges the additive from the additive container into the bottle according to a rotation of a part of the cap device, thus introducing the additive into the bottle and thus mixing the additive with a bottled liquid to prepare a mixture and allowing a user to easily prepare the mixture just prior to consuming or using the mixture.

It is another aspect of the present invention to provide a cap device for bottles, which has an actuating unit provided on a cap body to actuate the additive container while movably supporting the additive container, thus moving the additive container vertically relative to the cap body, the actuating unit capable of being in the form of a toy to arouse the user's curiosity, thus enhancing the market competitiveness of the products and increasing the use of the products.

Additional aspects and/or advantages of the invention will be set forth in part in the description which follows and, in part, will be obvious from the description, or may be learned by practice of the invention.

The above and/or other aspects are achieved by providing a cap device for bottles, comprising: a cap body having an internal thread to be secured to an external thread of a mouth of a bottle, with a valve part provided on a lower portion of the cap body and having an additive discharging port. The cap device further has an additive container to contain an additive therein. The additive container is received in the cap body to be moved vertically relative to the cap body in an axial direction of the cap body, thus opening or closing the additive discharging port of the valve part of the cap body. The additive container has a dispensing port provided on an upper end thereof to dispense a liquid of the bottle to an outside of the bottle, and the dispensing port is closed by a sub-cap. An actuating unit provided on the cap body actuates the additive container while movably supporting the additive container, thus moving the additive container vertically relative to the cap body.

The actuating unit can be in the shape of a toy having a body, head and arm, with the additive container received in the body of the toy to be moved vertically relative to both the body of the toy and the cap body. A rack gear axially is provided on an external surface of the additive container, and a pinion gear is provided on an inside end of the arm of the toy-shaped actuating unit to engage with the rack gear to allow the additive container to move vertically relative to both the toy body and the cap body by a rotation of the arm of the toy-shaped actuating unit relative to the toy body.

In an alternative construction of the actuating unit, the actuating unit has a body, a head engaged to the body, and an arm connected to body. An actuating external thread is provided on an upper portion of the additive container, and an actuating internal thread is provided on the head to engage with the actuating external thread of the additive container, wherein the additive container is moved vertically relative to both the body and the cap body by a rotation of the head of the actuating unit relative to the body.

In another alternative construction of the actuating unit, the actuating unit has a body, a head engaged to the body, and an arm connected to body. An actuating external thread is provided on the additive container, and an actuating internal thread is provided in the body to engage with the actuating external thread, wherein the additive container is moved vertically relative to both the body and the cap body by a rotation of the body of the actuating unit relative to the cap body.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing an appearance of a cap device for bottles when the cap device is secured to the mouth of a bottle;

FIG. 2 is an exploded perspective view of the cap device of FIG. 1;

FIGS. 3a and 3b are sectional views showing an operation of the cap device of FIG. 1;

FIG. 4 is an exploded perspective view of movable parts provided in the cap device of FIG. 1 to actuate the cap device;

FIGS. 5a and 5b are sectional views showing an operation of a cap device for bottles, according to a second embodiment of the present invention; and

FIGS. 6a and 6b are sectional views showing an operation of a cap device for bottles, according to a third embodiment of the present invention.

### DETAILED DESCRIPTION OF THE INVENTION

Reference will now be made in detail to the present preferred embodiments of the present invention, examples of which are illustrated in the accompanying drawings, wherein like reference numerals refer to like elements throughout. The embodiments are described below in order to explain the present invention by referring to the figures.

[First Embodiment]

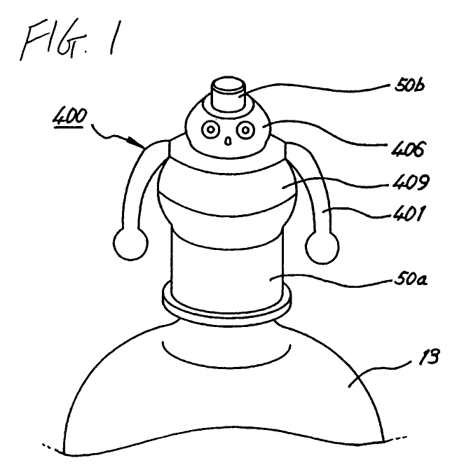

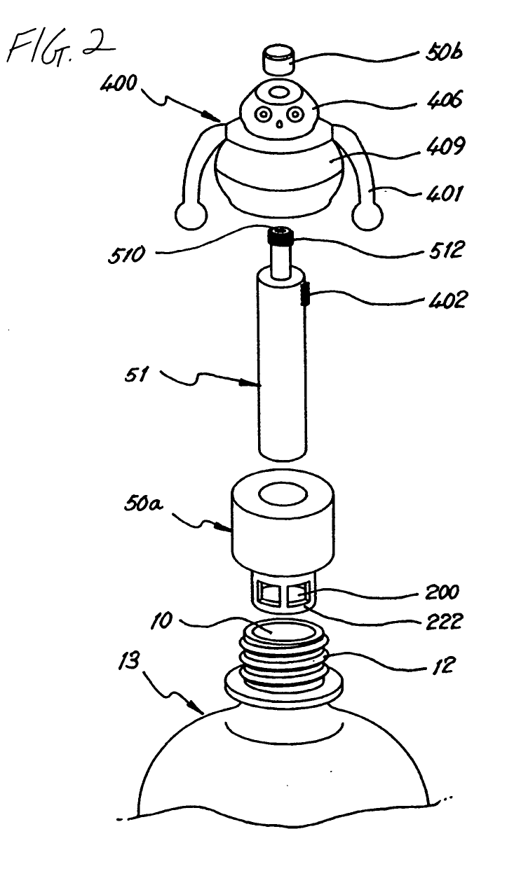

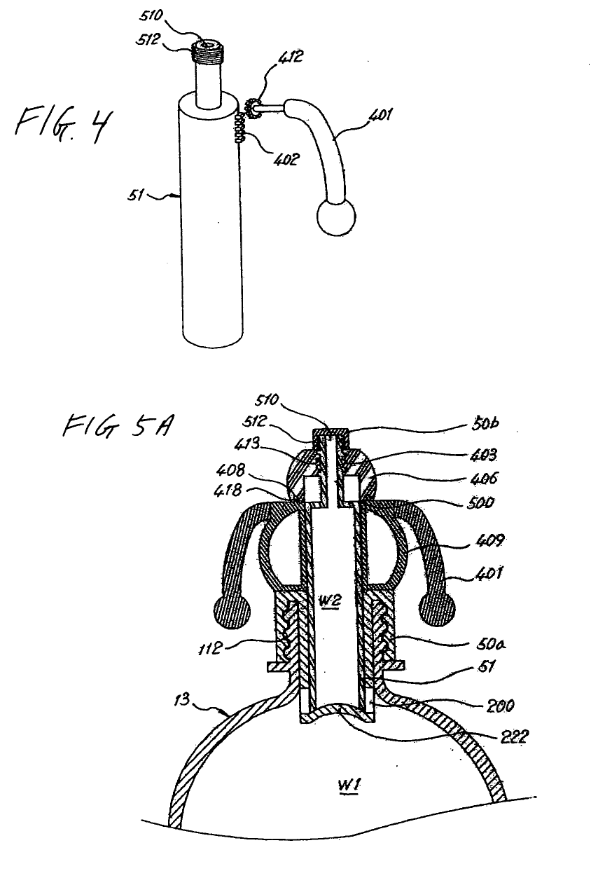

FIGS. 1 through 4 are views of a cap device for bottles according to a first embodiment of the present invention. As shown in FIGS. 1 through 4, the cap device for bottles according to the first embodiment of the present invention includes an additive container 51 to contain an additive therein, with a dispensing port 510 provided on an upper end of the additive container 51. The cap device further includes a cap body 50a secured to the mouth 10 of a bottle 13 through a screw-type engagement. Thus, the cap body 50a prevents undesired leakage of the contents from both the additive container 51 and the bottle 13 and prevents any change in the quality of the contents. The cap device further includes an actuating unit 400 to movably support the additive container 51 and to actuate the additive container 51 by a manual operation of a user.

The additive container 51 comprises a cylindrical body that is opened at a lower end thereof and contains a predetermined amount of additive therein. The cylindrical additive container 51 comprises an upper part and a lower part, with a rack gear 402 axially provided on an external surface of an upper portion of the lower part of the additive container 51. In the embodiment shown, the lower part has a first predetermined diameter larger than a second predetermined diameter of the upper part. The dispensing port 510 of the additive container 51 is provided on the upper end of the upper part of the additive container 51 and is closed by a sub-cap 50b. To secure the sub-cap 50b to the dispensing port 510 of the additive container 51, the upper end of the upper part of the additive container 51 is provided with an external thread 512, while the sub-cap 50b is provided with an internal thread. When the sub-cap 50b is secured to the dispensing port 510, the additive W2 is prevented from undesirably leaking from the additive container 51 through the dispensing port 510.

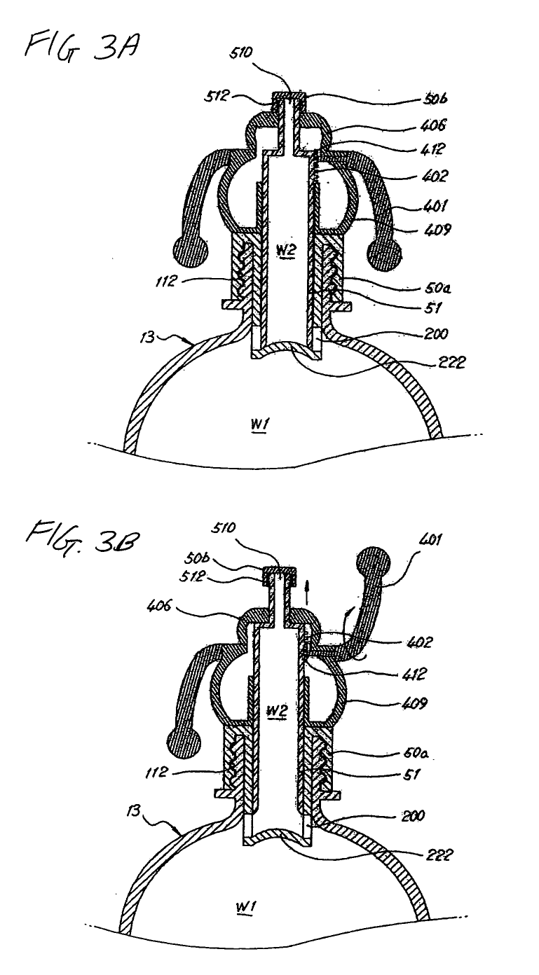

The cap body 50a has a double-walled structure with an internal thread 112 engaging with an external thread 12 of the mouth 10 of the bottle 13 when the cap body 50a is secured to the mouth 10 of the bottle 13. Thus, the cap body 50a prevents undesired leakage of the liquid W1 of the bottle 13 to an outside of the bottle 13 and prevents any change in the quality of the liquid W1. The cap body 50a has a valve part 222 at a lower portion thereof, with a plurality of additive discharging ports 200 provided at predetermined positions on the valve part 222 of the cap body 50a. The additive container 51 is movably received in the cap body 50a In a normal state, the opened lower end of the additive container 51 comes into close contact with an inner surface of a lower end of the valve part 222, so that the lower opening of the additive container 51 is closed by the valve part 222, and so as to close the additive discharging ports 200, as shown in FIG. 3a. Thus, the additive container 51 in the above state stores the additive W2 therein without allowing the additive W2 to leak into the bottle 13 before the user manually operates the cap device to open the additive discharging ports 200 of the valve part 222 of the cap body 50a and to discharge the additive W2 into the bottle 13 through the opened additive discharging ports 200.

The actuating unit 400 is mounted to the cap body 50a and includes a body 409, two arms 401 and a head 406. The body 409 is mounted to the cap body 50a, with the additive container 51 received in the body 409 to be moved vertically relative to both the body 409 and the cap body 50a. The two arms 401 are rotatably coupled to the shoulders of the toy body 409, respectively. A pinion gear 412 is provided on an inside end of one of the two arms 401 of the toy-shaped actuating unit 400 to engage with a rack gear 402 provided on the additive container 51. In this first embodiment, the arm 401 has the pinion gear 412 at the inside end thereof to function as an actuating arm to actuate the additive container 51. The head 406 of the actuating unit 400 is mounted above the body 409. When the user rotates the actuating arm 401 having the pinion gear 412 relative to the body 409 in a predetermined direction, the pinion gear 412 of the actuating arm 401 is rotated in the same direction to move the rack gear 402 of the additive container 51 upward, as shown by the arrow of FIG. 3b. With this upward movement of the additive container 51, the lower end of the additive container 51 is spaced apart from the lower end of the valve part 222 of the cap body 50a so that the additive W2 is discharged from the additive container 51 into the bottle 13 through the opened additive discharging ports 200. As such, the additive W2 is introduced into the bottle 13 to be mixed with the liquid W1 in the bottle 13. After preparing the mixture in the bottle 13, the user can consume or use the mixture by either removing the cap body 50a from the mouth 10 of the bottle 13 or by removing the sub-cap 50b from the dispensing port 510.

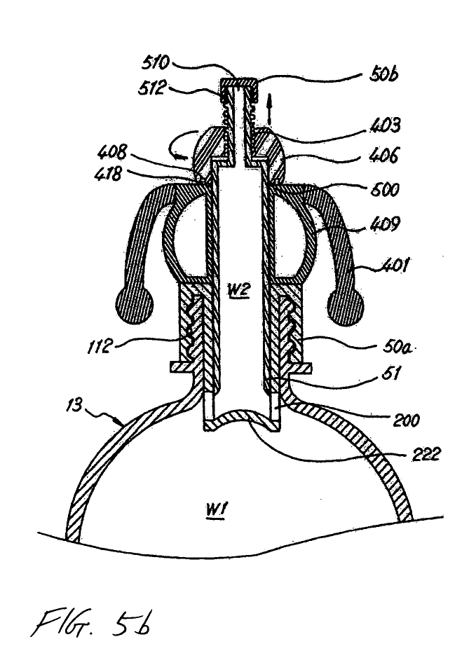

FIGS. 5a and 5b are sectional views showing an operation of a cap device for bottles, according to a second embodiment of the present invention. As shown in FIGS. 5a and 5b, the cap device for bottles according to the second embodiment of the present invention is constructed to discharge the additive W2 from the additive container 51 into the bottle 13 according to a rotation of the head 406 relative to the body 409 of the actuating unit 400, in place of the rotation of the actuating arm 401, different from the first embodiment.

The general shape of the cap device according to the second embodiment remains the same as that described for the first embodiment except for the structure allowing the rotation of the head 406 relative to the toy body 409 of the toy-shaped actuating unit 400. Those elements common to both the first and second embodiments will thus carry the same reference numerals, and further explanation of those elements is not deemed necessary. To allow the rotation of the head 406 relative to the toy body 409, a fitting groove 408 is formed on a lower end of the head 406, while a fitting protrusion 418 is formed on an upper end of the toy body 409 to correspond to the fitting groove 408. The fitting groove 408 of the head 406 is movably fitted over the fitting protrusion 418 of the toy body 409, so that the head 406 is rotated relative to the toy body 409. The cap device according to the second embodiment further includes an actuating external thread 403 which is provided around the external surface of the upper part of the additive container 51, and an actuating internal thread 413 provided in the head 406 of the actuating unit 400 to engage with the actuating external thread 403 of the additive container 51. The cap device of this embodiment also includes an O-ring 500 provided at a junction between the head 406 and the body 409 of the actuating unit 400 to prevent leakage of the additive W2 to an outside of the actuating unit 400.

When a user rotates the head 406 relative to the toy body 409 in a predetermined direction, the additive container 51 moves upward relative to both the toy body 409 and the cap body 50a due to the movable engagement of the actuating external thread 403 of the additive container 51 with the actuating internal thread 413 of the head 406. That is, both the movable engagement of the actuating internal thread 413 of the head 406 with the actuating external thread 403 of the additive container 51 and the movable fitting of the fitting protrusion 418 of the body 409 into the fitting groove 408 of the head 406 convert the rotation of the head 406 relative to the body 409 into the upward linear movement of the additive container 51 relative to both the body 409 and the cap body 50a. Thus, the lower end of the additive container 51 becomes spaced apart from the lower end of the valve part 222 of the cap body 50a so that the additive W2 is discharged from the additive container 51 into the bottle 13 through the opened additive discharging ports 200. The additive W2 is mixed with the liquid W1 in the bottle 13 to prepare a mixture.

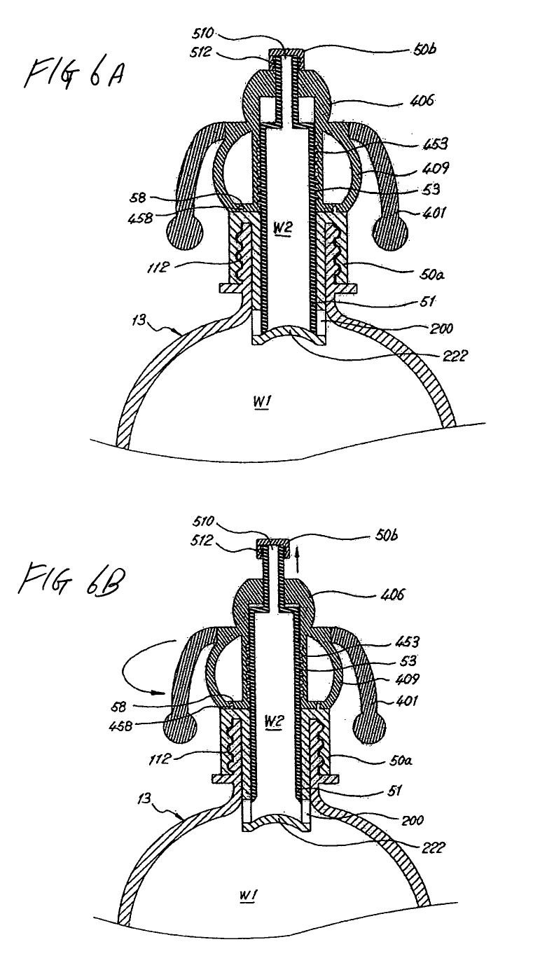

FIGS. 6a and 6b are sectional views showing an operation of a cap device for bottles, according to a third embodiment of the present invention. As shown in FIGS. 6a and 6b, the cap device for bottles according to the third embodiment of the present invention is constructed to discharge the additive W2 from the additive container 51 into the bottle 13 according to a rotation of the body 409 of the actuating unit 400 relative to the cap body 50a, in place of the rotation of the head 406 relative to the body 409, different from the second embodiment.

The general shape of the cap device according to the third embodiment remains the same as that described for the first embodiment, except for the structure allowing the rotation of the body 409 relative to the cap body 50a of the actuating unit 400. Those elements common to both the first and third embodiments will thus carry the same reference numerals, and further explanation of those elements is not deemed necessary. To allow the rotation of the body 409 relative to the cap body 50a, a fitting groove 58 is formed on a lower end of the body 409, while a fitting protrusion 458 is formed on an upper end of the cap body 50a to correspond to the fitting groove 58. The fitting groove 58 of the toy body 409 is movably fitted over the fitting protrusion 458 of the cap body 50a, so that the toy body 409 is rotated relative to the cap body 50a. The cap device according to the third embodiment further includes an actuating external thread 53 which is provided around an upper portion of the lower part of the additive container 51, and an actuating internal thread 453 which is provided in the body 409 to engage with the actuating external thread 53. In this third embodiment, when a user rotates the body 409 relative to the cap body 50a in a predetermined direction, the additive container 51 is moved upward relative to both the body 409 and the cap body 50a due to the movable engagement of the actuating external thread 53 of the additive container 51 with the actuating internal thread 453 of the body 409. That is, both the movable engagement of the actuating internal thread 453 of the body 409 with the actuating external thread 53 of the additive container 51 and the movable fitting of the fitting protrusion 458 of the cap body 50a into the fitting groove 58 of the toy body 409 convert the rotation of the body 409 relative to the cap body 50a into the upward linear movement of the additive container 51 relative to both the body 409 and the cap body 50a. Thus, the lower end of the additive container 51 is spaced apart from the lower end of the valve part 222 of the cap body 50a, so that the additive W2 is discharged from the additive container 51 into the bottle 13 through the opened additive discharging ports 200. The additive W2 is mixed with the liquid W1 in the bottle 13 to prepare a mixture.

Although embodiments of the present invention have been described for illustrative purposes, those skilled in the art will appreciate that various modifications, additions and substitutions are possible, without departing from the scope and spirit of the invention as disclosed in the accompanying claims. That is, in the embodiments of the present invention illustrated, the additive container is actuated by a rotation of the actuating arm, the head or the body of the actuating unit. However, the actuating unit may be constructed in that the body is divided into two parts, with an upper part of the divided toy body being rotated to actuate the additive container. As a further alternative, the actuating unit may be constructed to actuate the additive container by a joint movement, in place of the rotation of the actuating arm.

1. A cap device for a bottle having an externally threaded mouth, said cap device comprising:
a cap body having an internal thread to be secured to the externally threaded mouth of the bottle;
a valve part provided on a lower portion of the cap body, said valve part having an additive discharging port;
an additive container for containing an additive therein, said additive container disposed in the cap body in a manner allowing vertical movement relative to the cap body in an axial direction of the cap body to open or close the additive discharging port of the valve part depending on the position of the additive container;
a dispensing port provided on an upper end of the additive container for dispensing a liquid of the bottle to an outside of the bottle; a sub-cap for removably closing the dispensing port; and
an actuating unit for controlling the movement of the additive container.

2. The cap device according to claim 1, wherein the actuating unit comprises:
a body engaged to the cap body; a space extending through the body; at least a portion of said additive container slideably disposed through said space of said body;
at least one arm coupled to a said body; and
a head mounted to an upper end of said body.

3. The cap device for bottles according to claim 2, further comprising:
a rack gear axially provided on an external surface of said additive container; and
a pinion gear provided on said arm of the actuating unit to engage with the rack gear,
wherein the additive container is moved vertically relative to both the body and the cap body by a predetermined movement of the arm of the actuating unit relative to said body.

4. The cap device according to claim 2, further comprising:
an actuating external thread provided on an upper portion of the additive container; and
an actuating internal thread provided in the head of the toy-shaped actuating unit engaged to the actuating external thread of the additive container,
wherein the additive container is moved vertically relative to both the body and the cap body by a rotation of the head of the actuating unit relative to the toy body.

5. The cap device according to claim 2, further comprising:
an actuating external thread provided on said additive container; and
an actuating internal thread provided in the body engaged with said actuating external thread of said additive container,
wherein the additive container is moved vertically relative to both the body and the cap body by a rotation of the body of the actuating unit relative to the cap body.

6. A cap device for a bottle having an externally threaded mouth, said cap device comprising:
a cap body having an internal thread to be secured to the externally threaded mouth of the bottle;
a valve part provided on a lower portion of the cap body, said valve part having an additive discharging port;
an additive container for containing an additive therein, said additive container disposed in the cap body in a manner allowing vertical movement relative to the cap body in an axial direction of the cap body to open or close the additive discharging port of the valve part depending on the position of the additive container;
a dispensing port provided on an upper end of the additive container for dispensing a liquid of the bottle to an outside of the bottle; a sub-cap for removably closing the dispensing port; and
an actuating unit for controlling the movement of the additive container, said actuating unit having a body, at least one arm engaged to said body, and a head;
a space extending through said body; at least a portion of said additive container slideably disposed through said space of said body;
wherein the additive container is moved vertically relative to both the body and the cap body by a predetermined movement of a part of the actuating unit.
